(19) United States
(12) Patent Application Publication
(10) Pub. No.: US 2005/0121989 A1
(43) Pub. Date: Jun. 9, 2005

(54) Brushless motor having claw pole type stator

(75) Inventor: Mikitsugu Suzuki, Hoi-gun (JP)

Correspondence Address: POSZ LAW GROUP, PLC, 12040 SOUTH LAKES DRIVE, SUITE 101, RESTON, VA, 20191, US

(73) Assignee: ASMO CO., LTD.

(21) Appl. No.: 11/000,237

(22) Filed: Dec. 1, 2004

(30) Foreign Application Priority Data
Dec. 5, 2003 (JP) 2003-407633

(51) Int. Cl. H02K 37/00; H02K 21/12

(52) U.S. Cl. 310/156.06; 310/68 B; 310/257

(57) ABSTRACT

A stator includes two yokes and two coils. Each yoke is a claw pole type and has a plurality of pole teeth, which extend in an axial direction. The yokes are axially opposed to each other in such a manner that the pole teeth of one of the yokes and the pole teeth of the other one of the yokes are alternately arranged in a circumferential direction. The coils are circumferentially wound to form two phases, respectively, and are arranged between the yokes. A rotor includes a plurality of rotor magnets, each of which provides a magnetic pole. A single magnetic position sensor senses a rotational position of the rotor and outputs a position measurement signal, which indicates the sensed rotational position of the rotor. A half-wave electric current is alternately supplied to the coils based on the position measurement signal.

### CROSS REFERENCE TO RELATED APPLICATION

This application is based on and incorporates herein by reference Japanese Patent Application No. 2003-407633 filed on Dec. 5, 2003 and Japanese Patent Application No. 2004-327690 filed on Nov. 11, 2004.

### BACKGROUND OF THE INVENTION

1. Field of the Invention

The present invention relates to a brushless motor, and particularly to a brushless motor, which has a claw pole type stator.

2. Description of Related Art

One type of brushless stepping motor includes a claw pole type stator and a rotor. The claw pole type stator has a plurality of pole teeth, which are made by, for example, processing a magnetic sheet metal material. The rotor includes a plurality of permanent magnets, which are opposed to the stator. In the stator, coil bobbins, around which coils are wound, are axially arranged one after another. In this stepping motor, the pole teeth are made through the sheet metal processing, so that the manufacturing costs can be made low. Also, the coils can be easily wound around the coil bobbins by open winding.

Japanese Examined Utility Model Publication No. 2559692 discloses one such a stepping motor, which is an outer rotor type. In this stepping motor, the coil bobbins, around which the coils are wound, are axially arranged one after another. Furthermore, an outer yoke of the stator covers outer peripheral surfaces of the coil bobbins. The outer yoke is formed by rolling a magnetic plate material into a cylindrical shape, and a plurality of slits is made in a peripheral wall of the outer yoke to form the pole teeth in the outer yoke. Ring shaped permanent magnets are coaxially arranged at radially outward of the outer yoke. An inner magnetic pole surface of each permanent magnet is opposed to the pole teeth of the outer yoke in such a manner that a small gap is provided between the inner magnetic pole surface of the permanent magnet and the pole teeth of the outer yoke.

In general, in the claw pole type stepping motor, the respective bobbins are axially clamped by two metal components, each of which is made through the sheet metal processing and each of which has pole teeth. At this time, the two metal components are opposed to each other and clamp the coil bobbins therebetween in such a manner that the pole teeth of one of the two metal components and the pole teeth of the other one of the two metal components are alternately arranged in the circumferential direction. In contrast, in the stepping motor of Japanese Examined Utility Model Publication No. 2559692, the outer peripheral surfaces of the two coil bobbins are covered by the cylindrical magnetic material. Thus, the structure is relatively simple.

However, when the above stepping motor is used as, for example, a drive source, such as an electric fan motor, which continuously rotates, the stepping motor would be desynchronized. The desynchronization occurs more often at a high rotational speed, which is equal to or greater than 1000 rpm. To address the above disadvantage, Japanese Unexamined Patent Publication No. 2001-78392 discloses another type of stepping motor, which has two position sensors to control the rotation of the motor through a closed loop control operation. In the stepping motor of Japanese Unexamined Patent Publication No. 2001-78392, coils are wound around coil bobbins, which are axially arranged one after another, and the coil bobbins are held by yokes or yoke parts made of a magnetic material. Hall elements, which serve as the sensors, are provided at two predetermined circumferential positions, which are axially opposed to end surfaces of permanent magnets of an inner rotor. With this structure, phase detection can be relatively accurately performed to limit desynchronization.

However, the stepping motor recited in Japanese Unexamined Patent Publication No. 2001-78392 is intended to precisely rotate a predetermined angle at a low speed, which is equal to or smaller than 500 rpm. Also, the coil bobbins are displaced one half pitch from each other and are held by the two yokes. The two Hall elements are provided to sense the displacement of the one half pitch. Therefore, the structure is relatively complicated, and the manufacturing costs are relatively high. For example, when the stepping motor of Japanese Unexamined Patent Publication No. 2001-78392 is used in the electric fan motor, which does not require the high positional accuracy, manufacturing costs of an electric fan system, which has the electric fan motor, are disadvantageously increased.

### SUMMARY OF THE INVENTION

The present invention addresses the above disadvantages. Thus, it is an objective of the present invention to provide a brushless motor of continuously rotating type, which has a claw pole type stator and is structurally simple to achieve low manufacturing costs.

To achieve the objective of the present invention, there is provided a brushless motor, which includes a stator, a rotor and a single magnetic position sensor. The stator includes first and second yokes and first and second coils. Each of the first and second yokes is a claw pole type and has a plurality of pole teeth, which extend in an axial direction. The first and second yokes are axially opposed to each other in such a manner that the pole teeth of the first yoke and the pole teeth of the second yoke are alternately arranged in a circumferential direction. The first and second coils are circumferentially wound to form first and second phases, respectively, and are arranged between the first yoke and the second yoke. The rotor includes at least one rotor magnet, which provides a plurality of magnetic poles. The at least one rotor magnet is radially opposed to the plurality of pole teeth of the first yoke and the plurality of pole teeth of the second yoke. The single magnetic position sensor senses a rotational position of the rotor and outputs a position measurement signal, which indicates the sensed rotational position of the rotor. A half-wave electric current is alternately supplied to the first and second coils based on the position measurement signal.

### BRIEF DESCRIPTION OF THE DRAWINGS

The invention, together with additional objectives, features and advantages thereof, will be best understood from the following description, the appended claims and the accompanying drawings in which:

FIG. 1 is a schematic cross sectional view of a brushless motor according to an embodiment of the present invention;

FIG. 2 is a front view of a rotor of the brushless motor;

FIG. 3 is an exploded perspective view of a stator of the brushless motor provided with a shaft and a bearing;

FIG. 4 is a partial enlarged view of a pole tooth of one of yokes of the stator;

FIG. 5 is a circuit diagram of a control circuit of the brushless motor;

FIG. 6 is a descriptive view showing supply of electric current to coils of the stator;

FIG. 7 is a deployed view of the yokes and rotor magnets of the brushless motor;

FIG. 8A is a partial enlarged view showing a modification of the pole tooth;

FIG. 8B is a partial enlarged view showing another modification of the pole tooth;

FIG. 8C is a partial enlarged view showing another modification of the pole tooth;

FIG. 8D is a partial enlarged view showing another modification of the pole tooth;

FIG. 8E is a partial enlarged view showing another modification of the pole tooth;

FIG. 9 is a descriptive view showing arrangement of a Hall IC of the brushless motor;

FIG. 10 is a deployed view similar to FIG. 7, showing a modification of the rotor magnets;

FIG. 11 is a deployed view similar to FIG. 7, showing another modification of the rotor magnets; and

FIG. 12 is a deployed view similar to FIG. 7, showing a further modification of the rotor magnets.

### DETAILED DESCRIPTION OF THE INVENTION

One embodiment of the present invention will be described with reference to the accompanying drawings.

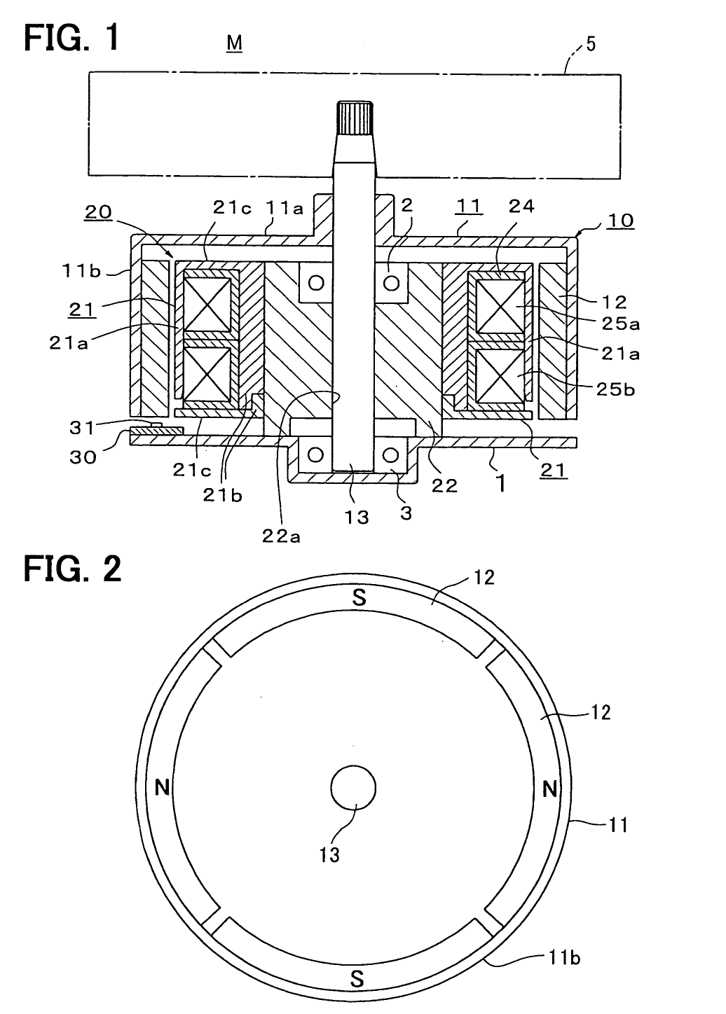

In the following embodiment, a brushless motor M of the present invention is embodied in a drive unit of an electric fan of a vehicle. With reference to FIG. 1, the brushless motor M is an outer rotor motor and includes a rotor 10 and a stator 20. The stator 20 is arranged radially inward of the rotor 10. The rotor 10 includes a case 11, a shaft 13 and permanent magnets (rotor magnets) 12. The case 11 includes a circular flat portion 11a and a cylindrical peripheral wall portion 11b. The peripheral wall portion 11b extends axially from an outer peripheral edge of the flat portion 11a. The shaft 13 is received through a through hole, which penetrates through a center of the flat portion 11a, and the shaft 13 is secured to the flat portion 11a. The rotor magnets 12 form magnetic poles, respectively, and are secured to an inner peripheral surface of the peripheral wall portion 11b. A fan 5 is connected to a distal end of the shaft 13. The fan 5 is rotated in one direction upon rotation of the rotor 10.

As shown in FIG. 2, each rotor magnet 12 is formed as a thin magnet, which is curved along an arc and which forms the magnetic pole. Furthermore, each rotor magnet 12 is magnetized in such a manner that a magnetic flux of the rotor magnet 12 is oriented in a radial direction. The rotor 10 of the present embodiment has four magnetic poles. Thus, four separate rotor magnets 12 are secured to the inner peripheral surface of the peripheral wall portion 11b to form the four magnetic poles. The rotor magnets 12 of opposite polarities are arranged alternately in a circumferential direction in such a manner that a direction of the magnetic flux of one of respective adjacent two of the rotor magnets 12 relative to a rotational axis of the shaft 13 is opposite from a direction of the magnetic flux of the other one of the respective adjacent two of the rotor magnets 12 relative to the rotational axis.

Although the rotor 10 of the present embodiment includes the separate rotor magnets 12, the present invention is not limited to this arrangement. For example, in place of the separate rotor magnets 12, a single annular rotor magnet can be press fitted into the case 11. In such a case, the single annular rotor magnet should be magnetized to have a plurality of magnetic poles in such a manner that the direction of the respective magnetic flux changes every predetermined angular interval (in the case of the four magnetic poles, the predetermined angular interval is about 90 degrees).

The stator 20 includes a cylindrical spacer 22, two yokes (first and second yokes of a claw pole type) 21, and two coil bobbins (first and second coil bobbins) 24. The spacer 22 is made of a non-magnetic material, such as a synthetic resin material. Each yoke 21 is arranged radially outward of the spacer 22 and includes two pole teeth 21a, which extend in the axial direction and are opposed to the rotor magnets 12. The coil bobbins 24 are arranged radially inward of the pole teeth 21a and are made of a non-magnetic material. Two coils (first and second coils) 25a, 25b are circumferentially wound around the coil bobbins 24, respectively. A through hole 22a is formed through a center of the spacer 22, and a bearing 2 is securely press fitted to one end of the spacer 22. The other end of the spacer 22 is secured to an end plate 1, and a bearing 3 is provided to the end plate 1. The bearings 2, 3 rotatably support the shaft 13, which is received through the through hole 22a.

In the stator 20 of the present embodiment, the two coil bobbins 24 are stacked one after another in the axial direction. The coil 25a conducts an A-phase electric current and is wound around one of the two coil bobbins 24, and the coil 25b conducts a B-phase electric current and is wound around the other one of the two coil bobbins 24. The coils 25a, 25b are wound in opposite directions, and the A-phase electric current (a first-phase electric current) and the B-phase electric current (a second-phase electric current) are supplied to the coils 25a, 25b, respectively, in a common direction. Thus, at the time of energizing the coils 25a, 25b, magnetic fields of opposite directions are generated. The stacked coil bobbins 24 are secured in the stator 20 in such a manner that the coil bobbins 24 are clamped between the two yokes 21.

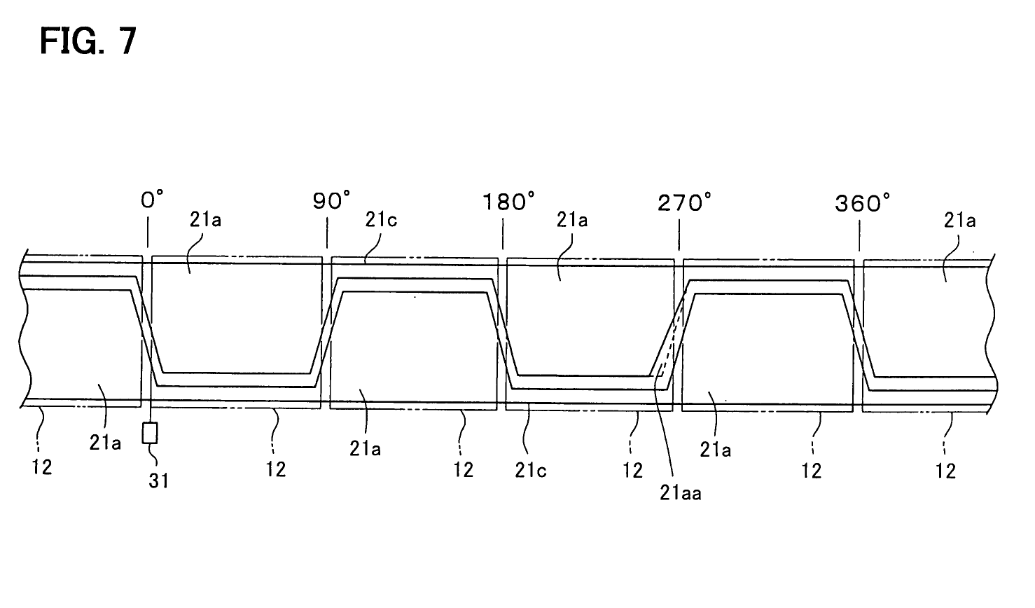

Each yoke 21 is made of a magnetic material and includes the two pole teeth 21a, an inner yoke portion 21b and an annular portion 21c. The pole teeth 21a serve as outer yoke portions, which cover outer peripheral surfaces of the coil bobbins 24. The inner yoke portion 21b covers an inner peripheral surface of the adjacent coil bobbin 24. The annular portion 21c connects between the inner yoke portion 21b and the pole teeth 21a and covers an end surface of the adjacent coil bobbin 24. The two yokes 21 are integrally connected to one another in the axial direction in such a manner that the inner yoke portions 21b of the yokes 21 are fitted to each other. Each yoke 21 is made through sheet metal processing in such a manner that the two pole teeth 21a are circumferentially displaced 180 degrees from one another and extend from an outer peripheral edge of the annular portion 21c. Each pole tooth 21a of each yoke 21 has a decreasing circumferential width, which decreases toward its distal end, i.e., toward the annular portion 21c of the other yoke 21. In other words, each pole tooth 21a is tapered toward the annular portion 21c of the other yoke 21. A magnetic pole surface of each symmetrical ones (described later) of the pole teeth 21a has a circumferential width, which is the same as a pole width of the rotor magnet 12. As shown in FIG. 7, when the pole tooth 21a is deployed in a plane, i.e., is unbent to extend in the plane, the magnetic pole surface of the pole tooth 21a has a generally trapezoidal shape the annular portion 21c side of the pole tooth 21a is a long side of the trapezoidal shape, and the distal end side of the pole tooth 21a is a short side of the trapezoidal shape. The pole teeth 21a are arranged in opposed relationship to the rotor magnets 12 to make a magnetic interaction with the rotor magnets 12. Furthermore, as described above, each pole tooth 21a is formed into the trapezoidal shape, which has the decreasing circumferential width that decreases toward its distal end. Thus, when the two yokes 21 are axially assembled together, the pole teeth 21a of one of the yokes 21 do not physically interfere with the pole teeth 21a of the other one of the yokes 21.

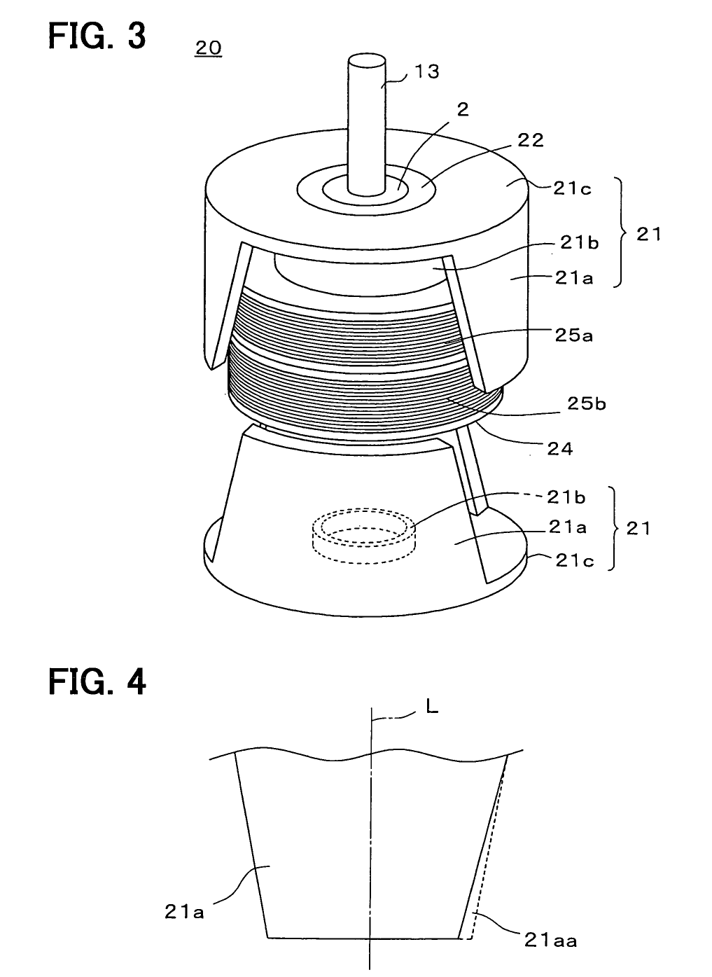

As shown in FIG. 3, at the time of assembling the stator 20, the coil bobbins 24, around which the coils 25a, 25b are respectively wound, are received in one of the yokes 21. Then, the other one of the yokes 21 is coaxially installed to the one of the yokes 21 in opposed relationship in such a manner that a phase of each of the pole teeth 21a of the other one of the yokes 21 is shifted about 90 degrees from a phase of an adjacent one of the pole teeth 21a of the one of the yokes 21. Then, the spacer 22 is press fitted into the yokes 21. Thus, the stator 20 includes the four pole teeth 21a, which form the four magnetic poles. The brushless motor M (more specifically, the rotor 10 of the brushless motor M) of the present embodiment is normally continuously rotated at a high speed, which is equal to or greater than 1,000 rpm, so that it is not required to set fine step angles. Therefore, the structure of the brushless motor M is relatively simple.

Furthermore, as shown in FIG. 4, at least one (but not all) of the four pole teeth 21a is made to have a non-symmetrical magnetic pole surface, which is radially opposed to the rotor magnet(s) 12 and is non-symmetrical about a center axis L (i.e., the rotational axis of the shaft 13) while the rest (the symmetric pole teeth 21a) of the four pole teeth 21a has a symmetrical magnetic pole surface, which is symmetrical about the center axis L. In the present embodiment, one circumferential end of the one non-symmetrical pole tooth 21a has a notch 21aa, from which a generally triangular shaped end part is notched. In the brushless motor M of the present embodiment, the number of the magnetic poles of the rotor magnets 12 is four, and the number of the magnetic poles of the pole teeth 21a is also four. When the number of the magnetic poles of the rotor magnets 12 is equal to the number of the magnetic poles of the pole teeth 21a, the rotor magnets 12 and the pole teeth 21a could be held in a magnetically balanced state at the time of stopping the brushless motor M. Thus, even when the electric current is resupplied to the coils 25a, 25b of the stator 20, an electromotive force, which is required to rotate the rotor 10 of the brushless motor M, is not generated in the magnetically balanced state.

In the stator 20 of the present embodiment, the at least one of the pole teeth 21a is made to be slightly non-symmetrical about the center axis L, as described above. Thus, at the time of supplying the electric current, the corresponding rotor magnet 12 of the rotor 10 is slightly circumferentially shifted from this non-symmetrical pole tooth 21a. Therefore, at the time of supplying the electric current to the stator 20, the electromotive force is directed to one circumferential direction, and thereby rotation of the rotor 10 can be initiated. That is, although the pole teeth 21a are arranged at generally equal intervals in the circumferential direction, the formation of the notch 21aa in the non-symmetrical pole tooth 21a causes a reduction in the magnetic interaction of the non-symmetrical pole tooth 21a with the corresponding rotor magnet 12. Thus, one circumferential part of the stator 20, in which the non-symmetrical pole tooth 21a is provided, becomes magnetically unbalanced, so that a rotational force is generated in the one circumferential direction to initiate the rotation of the rotor 10.

The brushless motor M of the present embodiment is constructed to initiate the rotation in the one circumferential direction with the above-described simple structure. In the brushless motor M, as discussed above, then number of the magnetic poles of the rotor 10 is four, and then number of the magnetic poles of the stator 20 is also four. With such minimum numbers of the magnetic poles, the structure of the brushless motor M is simplified. It should be noted that then number of the magnetic poles in each of the rotor 10 and the stator 20 is not limited to four and can be changed to 2n where “n” is a natural number, which is equal to or greater than 2. Furthermore, the shape of the notch 21aa is not limited to the generally triangular shape and can be change to any other suitable shape, such as a rectangular shape, an arcuate shape.

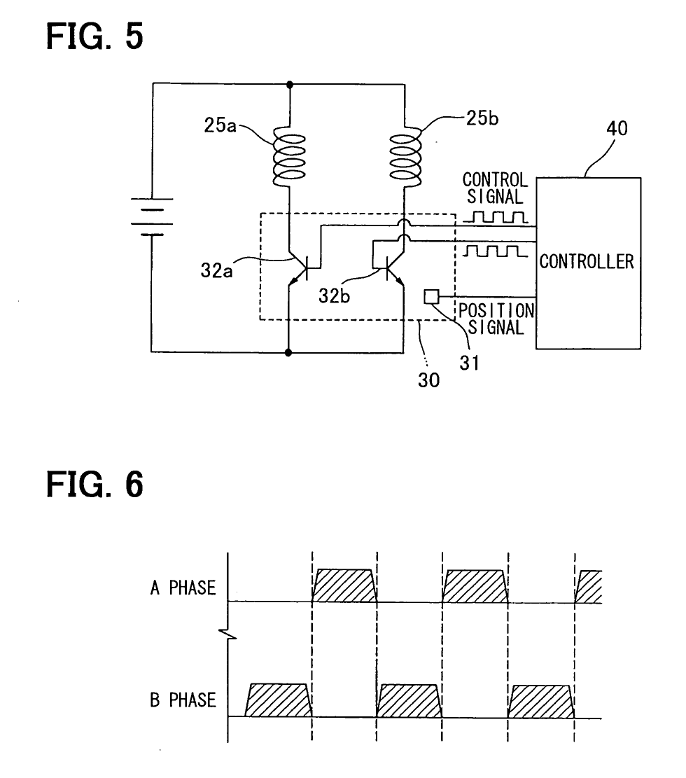

Furthermore, as shown in FIG. 1, a printed circuit board 30 is provided to an inner surface of the end plate 1. A Hall IC 31, which serves as single magnetic position sensor, is provided to the printed circuit board 30. When each rotor magnet 12 is rotate to axially oppose the Hall IC 31, the Hall IC 31 is axially opposed to the rotor magnet 12 in such a manner that a predetermined gap is formed between the Hall IC 31 and an adjacent axial end surface of the opposed rotor magnet 12. At the time of rotating the rotor 10, the Hall IC 31 senses the magnetism of the corresponding rotor magnet(s) 12 and outputs a position measurement signal, which indicates a rotational position of the rotor 10, to a controller 40 (FIG. 5). A switching point from the currently sensed magnetism sensed by the Hall IC 31 to the next magnetism corresponds to a switching point from the current rotor magnet 12 to the next rotor magnet 12. Accordingly, the controller 40 outputs a control signal to a control circuit of the printed circuit board 30 based on the position measurement signal to rotate the brushless motor M at the predetermined rotational speed.

As shown in FIG. 5, the control circuit of the printed circuit board 30 includes transistors 32a, 32b. The transistor 32a is connected to the coil 25a, which is for the A phase (the first phase). Furthermore, the transistor 32b is connected to the coil 25b, which is for the B phase (the second phase). When a pulse signal is inputted as the control signal from the controller 40 to a base terminal of a corresponding transistor 32a, 32b, a predetermined electric current flows through the corresponding coil 25a, 25b to generate a corresponding magnetic field. As shown in FIG. 6, the stator 20 of the present embodiment is supplied with a half-wave electric current, which is supplied in such a manner that the electric current of the A phase and the electric current of the B phase do not overlap with one another. Since the half-wave electric current is supplied to the stator 20, the electrical circuit construction is relatively simple.

Furthermore, as described above, the coil 25a is wound in the direction opposite from that of the coil 25b. Thus, when the half-wave electric current is alternately supplied to the A phase and the B phase, respective adjacent two pole teeth 21a, which respectively have opposite polarities, will change their polarities (N and S poles) from time to time to make the magnetic interaction with the corresponding rotor magnets 12. When the control signal is supplied from the controller 40 to the printed circuit board 30 at predetermined timing, the rotor 10 is continuously rotated in the single direction.

FIG. 7 is a deployed view of the pole teeth 21a of the yokes 21 and the rotor magnets 12, which are deployed in the plane along the circumferential direction and are seen in the radial direction. When each pole tooth 21a is deployed in the plane, the pole tooth 21a has the generally trapezoidal shape, in which the annular portion 21c side of the pole tooth 21a forms the long side of the generally trapezoidal shape, and the distal end side of the pole tooth 21a forms the short side of the generally trapezoidal shape. An average circumferential width of the magnetic pole surface (or a circumferential width of the axial center of the magnetic pole surface) of each symmetrical pole tooth 21a is set to be generally the same as the pole width of each rotor magnet 12 (or a circumferential width of the axial center of each rotor magnet 12). When the average circumferential width of the magnetic pole surface of the pole tooth 21a is set to be generally the same as the pole width of the rotor magnet 12, the magnetic flux generated therebetween can be most effectively used.

FIG. 7 shows the state, in which each pole tooth 21a is most significantly opposed to the corresponding rotor magnet 12, so that a radially overlapping surface area of the pole tooth 21a, which is overlapped with the corresponding rotor magnet 12 in the radial direction, is maximized. In other words, a radially overlapping total surface area of the pole teeth 21a of the yokes 21 relative to the rotor magnets 12 is maximized. In this state, the circumferential center of each symmetrical pole tooth 21a coincides with the circumferential center of the corresponding rotor magnet 12 in the radial direction.

The Hall IC 31 is arranged near a circumferential gap of the pole teeth 21a of the two yokes 21. More specifically, at the above rotational position of the rotor 10, in which each pole tooth 21a is most significantly overlapped with the corresponding rotor magnet 12 in the radial direction, the Hall IC 31 is arranged to overlap with the circumferential end of one of the rotor magnets 12 in the axial direction.

With this arrangement of the Hall IC 31, when the rotor 10 is rotated to the above rotational position, in which the overlapping surface area of each pole tooth 21a with the opposed rotor magnet 12 is maximized, i.e., when the maximum magnetic interaction is made between the pole tooth 21a and the opposed rotor magnet 12 (i.e., the time of generating the largest attractive or repulsive force), the Hall IC 31 senses the switching of the magnetism and outputs the corresponding signal, which indicates the switching of the rotor magnet 12, to the controller 40. The controller 40 can determine the time point of this switching upon receiving the above signal. The controller 40 switches the supply of the half-wave electric current between the A phase and the B phase at the time point of the switching (i.e., at a leading edge of the change in the magnetic flux measured through the Hall IC 31).

As described above, in the brushless motor M of the present embodiment, the supply of the half-wave electric current is switched at the above rotational position of the rotor 10, in which the maximum magnetic interaction occurs between each pole tooth 21a and the opposed rotor magnet 12. Therefore, the large drive force can be generated at the maximum efficiency.

Furthermore, the circumferential ends of each pole tooth 21a are slanted in the circumferential direction with respect to the axial direction, which is generally parallel to the axis of the shaft 13. The circumferential ends of the magnetic pole of each rotor magnet 12 of the present embodiment are generally parallel to the axial direction. In this way, in the brushless motor M of the present embodiment, when the rotor 10 is rotated in the predetermined direction, a degree of the magnetic interaction between each pole tooth 21a and the corresponding rotor magnet 12 can be gradually changed. Therefore, torque ripple of the brushless motor M can be reduced at the time of rotating the brushless motor M.

The circumferential width of each rotor magnet 12 is set to be larger than the circumferential width of the distal end (the short side) of each pole tooth 21a and is shorter than the base end (the long side where the annular portion 21c is located) of the pole tooth 21a. In this way, when the rotor 10 is rotated, the overlapping surface area of each pole tooth 21a with the corresponding rotor magnet 12 in the radial direction is progressively changed at the circumferential ends of the pole tooth 21a. In this way, the magnetic interaction between the pole tooth 21a and the corresponding rotor magnet 12 does not rapidly change, so that the torque ripple of the brushless motor M generated at the time of rotating the brushless motor M can be reduced.

As discussed above, the brushless motor M of the present embodiment has the stator 20. In the stator 20, the coil bobbins 24, around which the coils 25a, 25b are wound, are stacked one above the other, and the yokes 21 axially clamp the coil bobbins 24. The stator 20 has the claw pole structure, in which the pole teeth 21a extend in the yokes 21 to cover the outer peripheral surfaces of the two-phase coil bobbins 24. Thus, unlike the previously proposed brushless motor, in the stator 20 of the brushless motor M of the present embodiment, each coil bobbin 24 is not individually clamped by the corresponding two yokes, each of which has the pole teeth. Specifically, the two stacked coil bobbins 24 are integrally clamped by the two yokes 21 in the stator 20 of the brushless motor M of the present embodiment. More specifically, each pole tooth 21a extends over the two-phase coil bobbins 24. Therefore, the number of components of the stator 20 is minimized with the simple structure, and thereby the manufacturing costs can be minimized. Furthermore, the coils 25a, 25b are supplied with the half-wave electric current. Thus, the control circuit is relatively simple.

Furthermore, the two-phase coils 25a, 25b are supplied with the half-wave electric current, and the rotational position of the rotor 10 is sensed with the Hall IC 31. Then, the Hall IC 31 outputs the position measurement signal to the controller 40. In turn, the controller 40 controls the rotation of the brushless motor M. Thus, the brushless motor M can be continuously rotated without making the desynchronization. Furthermore, the half-wave electric current is alternately supplied to the two-phase coils 25a, 25b, so that only the one Hall IC 31 needs to be provided in the circumferential direction of the rotor 10.

Furthermore, in the brushless motor M of the present embodiment, although the number (four in the present embodiment) of the magnetic poles of the stator 20 is the same as the number (four in the present embodiment) of the magnetic poles of the rotor 10, the at least one of the pole teeth 21a of the stator 20 is made non-symmetrical about the center axis L to improve the startability of the brushless motor M. Therefore, the startability of the brushless motor M can be advantageously improved with the above simple structure.

The present embodiment can be modified as follows.

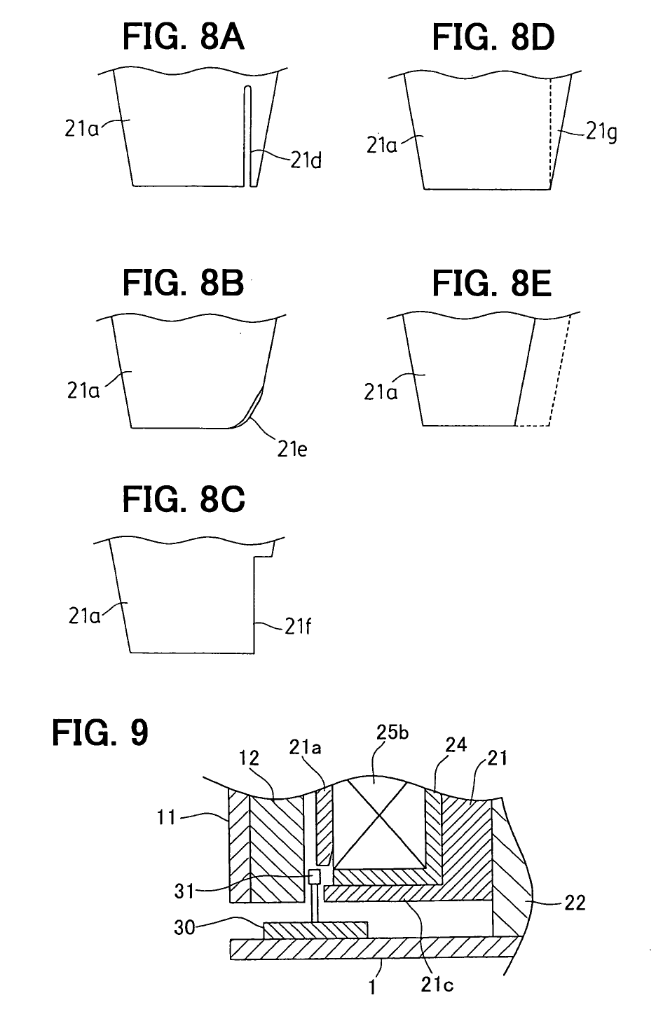

In the above embodiment, the one of the pole teeth 21a is made non-symmetrical about the center axis L by notching the one circumferential end of the pole tooth 21a. However, the present invention is not limited to this. For example, this pole tooth 21a can be modified to any other suitable shape, as shown in FIGS. 8A-8E. In FIG. 8A, a slit 21d is formed at a location adjacent to one of the circumferential ends of the pole tooth 21a to achieve the magnetic unbalance. In FIG. 8B, a curved portion 21e, which is radially slightly curved, is formed in the one of the circumferential ends of the pole tooth 21a. In FIG. 8C, a notch 21f is formed by largely notching the one of the circumferential ends of the pole tooth 21a. In FIG. 8D, a thin wall portion 21g is formed by radially thinning a wall of the one of the circumferential ends of the pole tooth 21a. In FIG. 8E, the pole tooth 21a is symmetrical. However, the circumferential width of the pole tooth 21a is shorter than the other pole teeth 21a, and thus the center is shifted a predetermined angle in the left direction in FIG. 8E. Even with the above modifications, the pole tooth 21a is still magnetically asymmetrical about the center axis L in the circumferential direction. Thus, the startability of the brushless motor M can be improved. It is only required to have at least one asymmetrical pole tooth 21a, which is shown in, for example, FIGS. 8A to 8E, to make the stator 20 magnetically asymmetrical with respect to the rotor 10 in the circumferential direction.

In the above embodiment, the Hall IC 31 is axially opposed to the axial end surface of the respective rotor magnet 12. However, the present invention is not limited to this. For example, the Hall IC 31 can be arranged in a manner shown in FIG. 9. Specifically, when one of the pole teeth 21a of one of the yokes 21 is rotated to a position shown in FIG. 9, the Hall IC 31 faces an axial space between the distal end of the one of the pole teeth 21a of the one of the yokes 21 and the annular portion 21c of the other one of the yokes 21. With this arrangement, the Hall IC 31 can sense a radial magnetic flux. In this way, a relatively large magnetism, which is larger than the axial magnetic flux, can be sensed, so that accuracy of sensing of the rotational position is improved. Furthermore, the Hall IC 31 is positioned to face the space between the two yokes 21, i.e., the axial space, which is defined between the pole teeth 21a of one of the yokes 21 and the other one of the yokes 21. Therefore, a loss of the magnetic flux, which is caused by the Hall IC 31 and would otherwise contribute to the rotation of the rotor 10, is reduced or minimized.

In the above embodiment, the outer rotor brushless motor M is described. However, the present invention is not limited to this. Alternatively, the present invention can be implemented in an inner rotor brushless motor. In the above embodiment, the number of the rotor magnets 12 is four, and the number of the pole teeth 21a is also four. However, as long as the number of the rotor magnets 12 and the number of the pole teeth 21a are even numbers and are equal to each other, any other appropriate number can be selected.

Furthermore, in the above embodiment, the coil 25a of the A-phase electric current and the coil 25b of the B-phase electric current are wound around the separate bobbins 24, respectively. However, the present invention is not limited to this. For example, the coils 25a, 25b may be wound around a single bobbin 24.

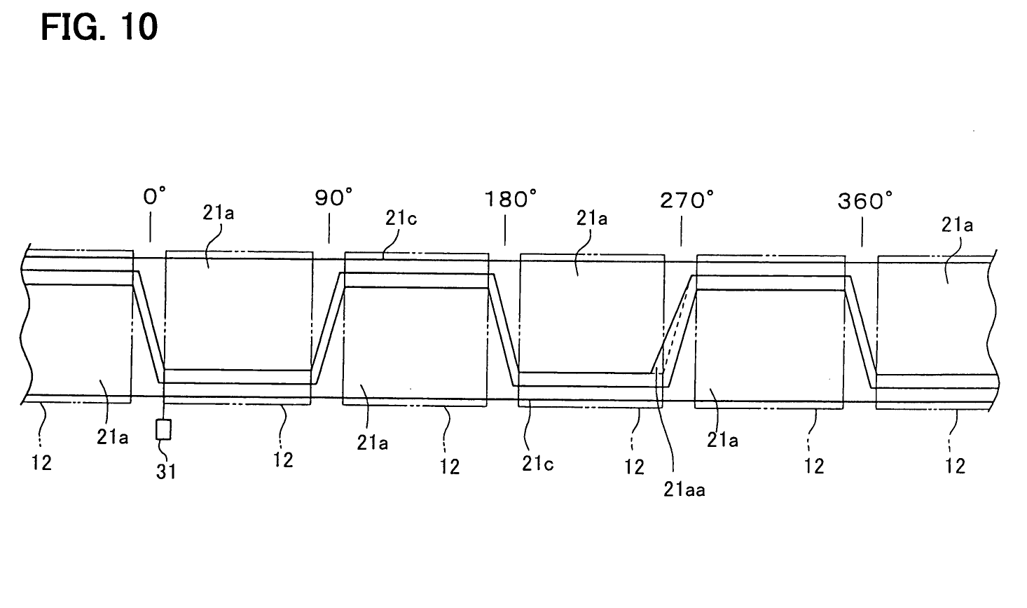

Furthermore, in the above embodiment, the circumferential width of each rotor magnet 12 is generally the same as the circumferential width of the axial center of the symmetrical pole tooth 21a, which is measured at the axial center of the pole tooth 21a, and the circumferential ends of the rotor magnet 12 are generally parallel to the axial direction. However, the present invention is not limited to this. For example, each rotor magnet 12 may be modified to any other appropriate shape, as shown in FIGS. 10 to 12.

In FIG. 10, the pole width of the rotor magnet 12 is set to be smaller than the circumferential width of the axial center of the symmetrical pole tooth 21a, which is measured at the axial center of the pole tooth 21a. In this example, the pole width of the rotor magnet 12 is set to be generally the same as the circumferential width of the distal end of the symmetrical pole tooth 21a. As shown in FIG. 10, even in this case, the Hall IC 31 is arranged to generally axially coincide with the circumferential end of the corresponding rotor magnet 12 at the time where the overlapping surface area of the pole tooth 21a with the rotor magnet 12 in the radial direction is maximized. When the Hall IC 31 is arranged in this way, it is possible to sense the rotational position of the rotor 10 where the maximum magnetic interaction occurs between the pole tooth 21a and the rotor magnet 12. Upon receiving this signal, the controller 40 can make the switching of the supply of the half-wave electric current to the coils 25a, 25b at the suitable timing, at which the maximum drive force is generated.

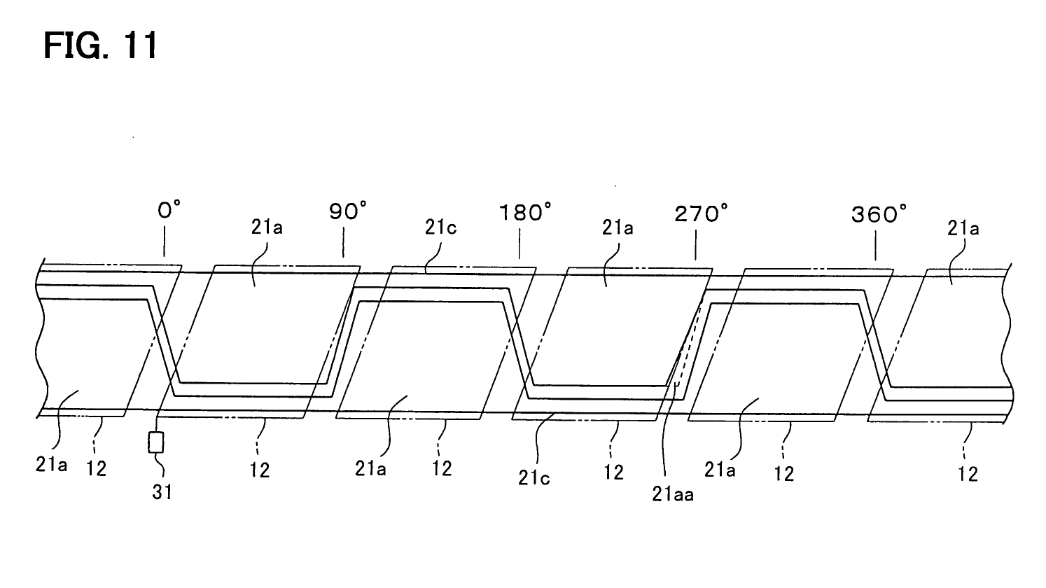

FIG. 11 shows the exemplary rotor magnets 12, each of which has a generally parallelogram shape in the deployed state. In FIG. 11, each rotor magnet 12, which is slanted, i.e., is skewed in the circumferential direction, is arranged to have a maximum overlapping surface area that overlaps with the corresponding pole tooth 21a. As shown in FIG. 11, in this case, the Hall IC 31 is arranged to generally axially coincide with the circumferential end (the end at the lower side in this case) of the corresponding rotor magnet 12. When the Hall IC 31 is arranged in this way, it is possible to sense the rotational position where the maximum magnetic interaction occurs between the pole tooth 21a and the rotor magnet 12.

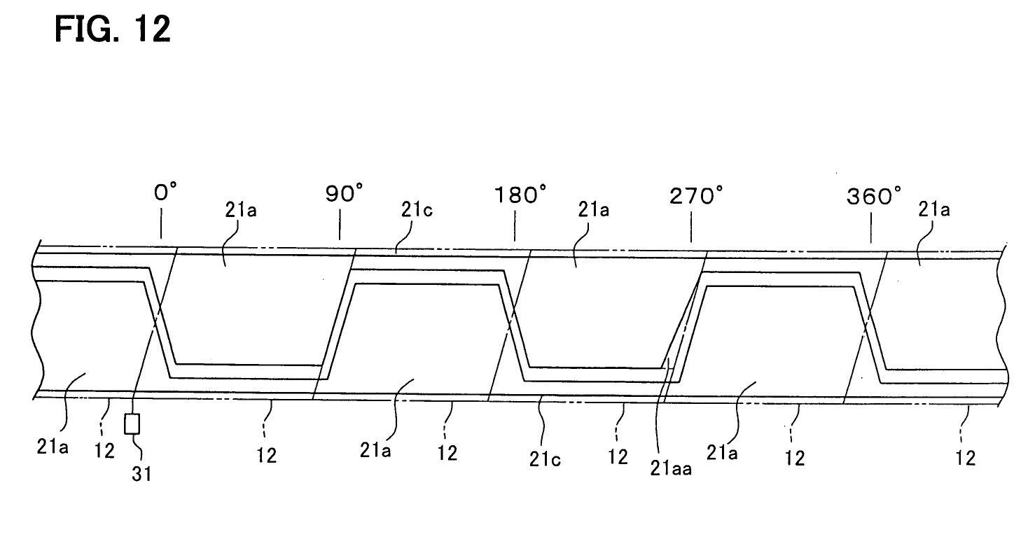

FIG. 12 shows another case where the pole width of each rotor magnet 12 of FIG. 11 is maximized. In other words, in FIG. 12, a circumferential space between respective adjacent rotor magnets 12 is eliminated or is substantially eliminated. Even in this case, when the Hall IC 31 is arranged to generally axially coincide with the circumferential end of the corresponding rotor magnet 12, it is possible to sense the rotational position of the rotor 10 where the maximum magnetic interaction occurs between the pole tooth 21a and the rotor magnet 12.

As discussed above, when the Hall IC 31 is arranged in the manner shown in FIG. 11 or FIG. 12, it is possible to sense the rotational position of the rotor 10 where the maximum magnetic interaction occurs between the pole tooth 21a and the rotor magnet 12. Thus, the controller 40, which receives the position measurement signal that indicates the above rotational position where the maximum magnetic interaction occurs, can make the switching of the supply of the half-wave electric current to the coils 25a, 25b at the suitable timing, at which the maximum drive force is generated.

Furthermore, by skewing the rotor magnets 12, the magnetic interaction between each pole tooth 21a and the corresponding rotor magnet 12 can be progressively changed during the rotation of the rotor 10. Therefore, torque ripple of the brushless motor M can be reduced at the time of rotating the brushless motor M.

Furthermore, it is preferred that a slant angle of each circumferential end edge of the rotor magnet 12 in the circumferential direction is made larger than a corresponding slant angle of an adjacent circumferential end edge of the corresponding pole tooth 21a. With this arrangement, the torque ripple of the brushless motor M can be more reduced to achieve more smooth rotation of the brushless motor M.

Additional advantages and modifications will readily occur to those skilled in the art. The invention in its broader terms is therefore not limited to the specific details, representative apparatus, and illustrative examples shown and described.

1. A brushless motor comprising:
a stator that includes first and second yokes and first and second coils, wherein:
each of the first and second yokes is a claw pole type and has a plurality of pole teeth, which extend in an axial direction;
the first and second yokes are axially opposed to each other in such a manner that the pole teeth of the first yoke and the pole teeth of the second yoke are alternately arranged in a circumferential direction; and
the first and second coils are circumferentially wound to form first and second phases, respectively, and are arranged between the first yoke and the second yoke;
a rotor that includes at least one rotor magnet, which provides a plurality of magnetic poles, wherein the at least one rotor magnet is radially opposed to the plurality of pole teeth of the first yoke and the plurality of pole teeth of the second yoke; and
a single magnetic position sensor that senses a rotational position of the rotor and outputs a position measurement signal, which indicates the sensed rotational position of the rotor, wherein a half-wave electric current is alternately supplied to the first and second coils based on the position measurement signal.

2. The brushless motor according to claim 1, further comprising a controller, which controls supply of the half-wave electric current to the first and second coils based on the position measurement signal, which is received from the position sensor.

3. The brushless motor according to claim 1, wherein:
a total number of the plurality of pole teeth of the first yoke and the plurality of pole teeth of the second yoke is equal to a total number of the plurality of magnetic poles of the at least one rotor magnet; and
a shape of at least one of the plurality of pole teeth of the first yoke and the plurality of pole teeth of the second yoke is different from that of the rest of the plurality of pole teeth of the first yoke and the plurality of pole teeth of the second yoke.

4. The brushless motor according to claim 3, wherein a portion of each of the at least one of the plurality of pole teeth of the first yoke and the plurality of pole teeth of the second yoke is notched.

5. The brushless motor according to claim 3, wherein a portion of each of the at least one of the plurality of pole teeth of the first yoke and the plurality of pole teeth of the second yoke is radially thinned relative to the rest of each of the at least one of the plurality of pole teeth of the first yoke and the plurality of pole teeth of the second yoke.

6. The brushless motor according to claim 1, wherein the position sensor is positioned to faces an axial space, which is defined between the plurality of pole teeth of one of the first and second yokes and the other one of the first and second yokes.

7. The brushless motor according to claim 1, wherein the first coil and the second coil are wound in opposite directions, respectively, and the half-wave electric current is alternately supplied to the first and second coils in a common direction, so that a magnetic flux generated by the first coil and a magnetic flux generated by the second coil flow in opposite directions, respectively.

8. The brushless motor according to claim 1, wherein a circumferential width of an axial center of one or more of the plurality of pole teeth of the first yoke and the plurality of pole teeth of the second yoke is generally the same as a circumferential width of an axial center of each of the plurality of the magnetic poles of the at least one rotor magnet.

9. The brushless motor according to claim 1, wherein switching of supply of the half-wave electric current between the first coil and the second coil is performed at a corresponding rotational position of the rotor, at which a radially overlapping total surface area of the plurality of pole teeth of the first yoke and the plurality of pole teeth of the second yoke relative to the plurality of magnetic poles of the at least one rotor magnet is maximized.

10. The brushless motor according to claim 1, wherein:
circumferential ends of each of the plurality of pole teeth of the first yoke and the plurality of pole teeth of the second yoke are slanted relative to the axial direction; and
circumferential ends of each of the plurality of magnetic poles of the at least one rotor magnet are generally parallel to the axial direction.

11. The brushless motor according to claim 1, wherein:
circumferential ends of each of the plurality of pole teeth of the first yoke and the plurality of pole teeth of the second yoke are slanted relative to the axial direction; and
circumferential ends of each of the plurality of magnetic poles of the at least one rotor magnet are slanted relative to the axial direction.

12. The brushless motor according to claim 1, wherein each of the plurality of pole teeth of the first yoke and the plurality of pole teeth of the second yoke is formed to have a generally trapezoidal shape when each of the plurality of pole teeth of the first yoke and the plurality of pole teeth of the second yoke is radially viewed, so that each pole tooth is tapered toward a distal end thereof.

13. The brushless motor according to claim 12, wherein:
the at least one rotor magnet includes a plurality of rotor magnets, each of which provide a corresponding one of the plurality of magnetic poles;
each of the plurality of rotor magnets is formed to have a generally rectangular shape when each of the plurality of rotor magnets is radially viewed; and
a circumferential width of each of the plurality of rotor magnets is larger than a circumferential width of the distal end of each of the plurality of pole teeth of the first yoke and the plurality of pole teeth of the second yoke.

14. The brushless motor according to claim 1, wherein:
a total number of the plurality of magnetic poles of the at least one rotor magnet is four; and
a total number of the plurality of pole teeth of the first yoke and the plurality of pole teeth of the second yoke is four.

15. The brushless motor according to claim 1, wherein the rotor is normally rotated at a rotational speed equal to or greater than 1,000 rpm.
